(19) United States
(12) Patent Application Publication
(10) Pub. No.: US 2024/0111936 A1
(43) Pub. Date: Apr. 4, 2024

(54) ROUTING METHOD FOR CIRCUIT BOARD

(71) Applicant: PEGATRON CORPORATION, Taipei City (TW)

(72) Inventor: YUNG-LIN HSIEH, TAIPEI CITY (TW)

(21) Appl. No.: 18/235,911

(22) Filed: Aug. 21, 2023

(30) Foreign Application Priority Data
Oct. 4, 2022 (TW) 111137621

(51) Int. Cl. G06F 30/394; H05K 3/00

(52) U.S. Cl. CPC G06F 30/394; H05K 3/0005; G06F 2115/12

(57) ABSTRACT

The present invention discloses a routing method for a circuit board, which is suitable for planning a plurality of traces to connect a plurality of first contacts of a first trace layer and a plurality of second contacts of a second trace layer, and at least includes the following steps: providing a plurality of virtual paths between the first contacts and the second contacts, and providing a plurality of virtual grid points on the virtual paths; setting a plurality of first serial numbers of the first contacts and a plurality of second serial numbers of the second contacts; dividing the traces into a first group, a second group and a third group according to a plurality of contact serial number differences between the second serial numbers and the first serial numbers; and providing a via hole of each trace on the virtual grid point.

### TECHNICAL FIELD

The present invention relates to a routing method, and in particular to a routing method for a circuit board, suitable for planning a plurality of traces of the circuit board.

### BACKGROUND

When routing on a circuit board, it is often necessary to switch a plurality of non-interleaved traces from one trace layer of the circuit board to another by using via holes in response to space planning, and these traces may be connected to non-adjacent contacts before and after layer switching. However, the conventional routing method relies on the routing experience of a worker and the use of trial and error, without standardized flows or steps, thus wasting a large amount of time.

### SUMMARY

For the deficiencies of the prior art, embodiments of the present invention provide a routing method for a circuit board, suitable for planning a plurality of traces of the circuit board. The circuit board includes a plurality of first contacts provided on a first trace layer and a plurality of second contacts provided on a second trace layer, the first contacts being arranged in a first direction, the second contacts being arranged in the first direction corresponding to the first contacts, and the first contacts being connected to the second contacts respectively by the traces. The routing method includes: providing a plurality of virtual paths between the first contacts and the second contacts corresponding thereto in arrangement order, and providing a plurality of virtual grid points on the virtual paths according to a number of the traces; setting a plurality of first serial numbers of the first contacts according to the arrangement order of the first contacts in the first direction, and setting a plurality of second serial numbers of the second contacts according to the arrangement order of the second contacts in the first direction; for the first contacts and the second contacts correspondingly connected to the plurality of traces, calculating multiple contact serial number differences between the second serial numbers of the second contacts and the first serial numbers of the first contacts; dividing the traces into a first group, a second group and a third group according to the contact serial number differences; and providing a plurality of via holes on the virtual grid points according to the number of the traces, wherein in the first group and the second group, the via hole of each trace is located on the virtual path corresponding to the first contact connected to the trace, and in the third group, the via hole of each trace is located on the virtual path corresponding to the second contact connected to the trace, so that the traces cross over from the first trace layer to the second trace layer through the via holes to connect the second contacts.

Further, the first serial numbers of the first contacts are equal to the second serial numbers of the second contacts of the second contacts corresponding to the first contacts in the arrangement order.

Further, when the first serial numbers and the second serial numbers are set in increments in the first direction, the traces with the contact serial number differences being positive values are assigned to the first group, the traces with the contact serial number differences being zero are assigned to the second group, and the traces with the contact serial number differences being negative values are assigned to the third group.

Further, the routing method further includes: laying the traces of the first group in descending order of the second serial numbers of the second contacts connected to the traces of the first group.

Further, the routing method further includes: laying the traces of the third group in ascending order of the first serial numbers of the first contacts connected to the traces of the third group.

Further, a number of the virtual grid points is n*n, each of the virtual paths has n virtual grid points, and n is the number of the traces.

Further, the traces of the first group are laid out in the first trace layer in a second direction perpendicular to the first direction, and after each trace of the first group passes through the corresponding via hole from the first trace layer to the second trace layer, each trace of the first group is laid out in the first direction until reaching the virtual path corresponding to the second contact connected to the trace, and then is laid out in the second direction to connect the second contacts.

Further, the traces of the second group are laid out in the first trace layer and the second trace layer in the second direction.

Further, each trace of the third group is laid out in the first trace layer in the second direction, then is laid out in a third direction opposite to the first direction until reaching the virtual path corresponding to the second contact connected to the trace, and then passes through the via hole to the second trace layer.

Further, each trace of the third group is laid out in the second direction after passing through the corresponding via hole from the first trace layer to the second trace layer.

Further, each of the traces of one of the first group and the third group includes one turn in the second trace layer, and each of the traces of the other of the first group and the third group includes one turn in the first trace layer.

In summary, according to the routing method provided by the present invention, by the technical means of “providing the plurality of virtual paths between the first contacts of the first trace layer and the second contacts of the second trace layer, and providing the plurality of virtual grid points on the virtual paths according to the number of the traces”, “setting the plurality of first serial numbers of the first contacts and the plurality of second serial numbers of the second contacts in the same way”; “calculating the contact serial number difference”, “dividing the traces into the first group, the second group and the third group according to the contact serial number differences”, and “providing the plurality of via holes on the virtual grid points according to the number of the traces, wherein in the first group and the second group, the via hole of each trace is located on the virtual path corresponding to the first contact connected to the trace, and in the third group, the via hole of each trace is located on the virtual path corresponding to the second contact connected to the trace”, the traces cross over from the first trace layer to the second trace layer through the via holes so as to connect the second contacts. Therefore, one of the beneficial effects of the present invention is to propose standardized and clear flow steps so as to reduce reliance on the routing experience of a worker, thus avoiding wasting of a large amount of time.

In order to enable a further understanding of the features and technical content of the present invention, refer to the following detailed description and drawings of the present invention. However, the provided drawings are only for reference and explanation and not intended to limit the present invention.

### BRIEF DESCRIPTION OF THE DRAWINGS

FIG. 1 is a flowchart showing steps of a routing method provided by an embodiment of the present invention.

FIG. 2 is a schematic diagram of a circuit board provided by an embodiment of the present invention.

FIG. 3 is a schematic diagram of a connection relationship between first contacts and second contacts in FIG. 2.

FIG. 4 is a schematic diagram of a plurality of virtual paths and a plurality of virtual grid points according to an embodiment of the present invention.

FIGS. 5A to 5D are schematic diagrams of laying traces of a first group according to an embodiment of the present invention.

FIGS. 6A to 6B are schematic diagrams of laying traces of a second group according to an embodiment of the present invention.

FIGS. 7A to 7D are schematic diagrams of laying traces of a third group according to an embodiment of the present invention.

### DETAILED DESCRIPTION

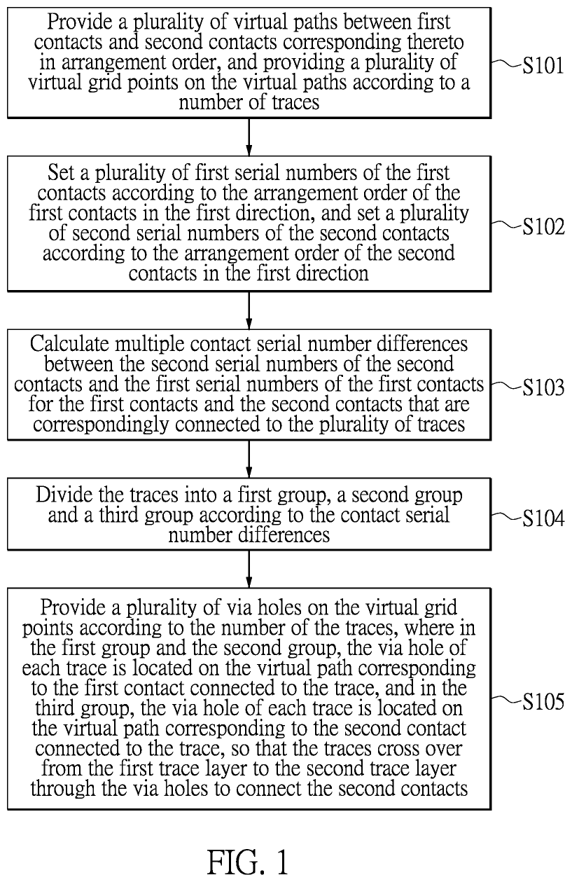

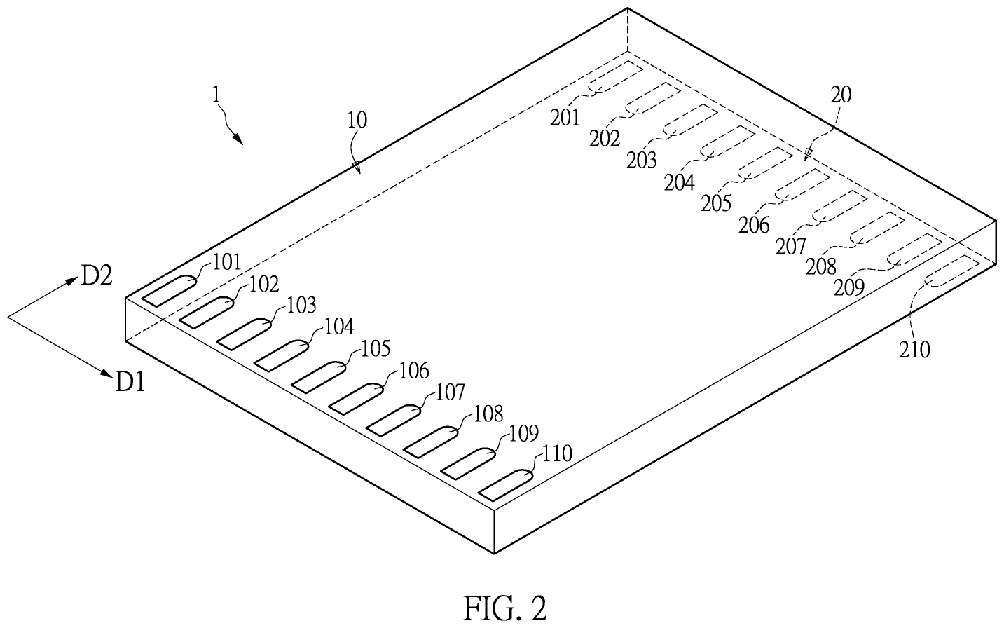

Referring to FIGS. 1 and 2, FIG. 1 is a flowchart showing steps of a routing method provided by an embodiment of the present invention, and FIG. 2 is a schematic diagram of a circuit board provided by an embodiment of the present invention. As shown in FIG. 2, a circuit board 1 includes a first trace layer 10 and a second trace layer 20. In this embodiment, the circuit board 1 may be a printed circuit board, and the first trace layer 10 and the second trace layer 20 are an upper surface and a lower surface of the printed circuit board, but the present invention is not limited by this. In addition, the circuit board 1 includes a plurality of first contacts 101 to 110 provided on the first trace layer 10 and a plurality of second contacts 201 to 210 provided on the second trace layer 20.

The first contacts 101 to 110 are arranged in a first direction D1, and the second contacts 201 to 210 are arranged in the first direction D1 corresponding to the first contacts 101 to 110. In other words, an arrangement direction of the second contacts 201 to 210 may be parallel to that of the first contacts 101 to 110. In addition, the first contacts 101 to 110 are connected to the second contacts 201 to 210 through a plurality of traces. It is noted that for the convenience of the following explanation, only 10 first/second contacts, namely 101 to 110 and 201 to 210 in FIG. 2, are taken as an example in this embodiment, but the present invention does not limit the specific number of first/second contacts.

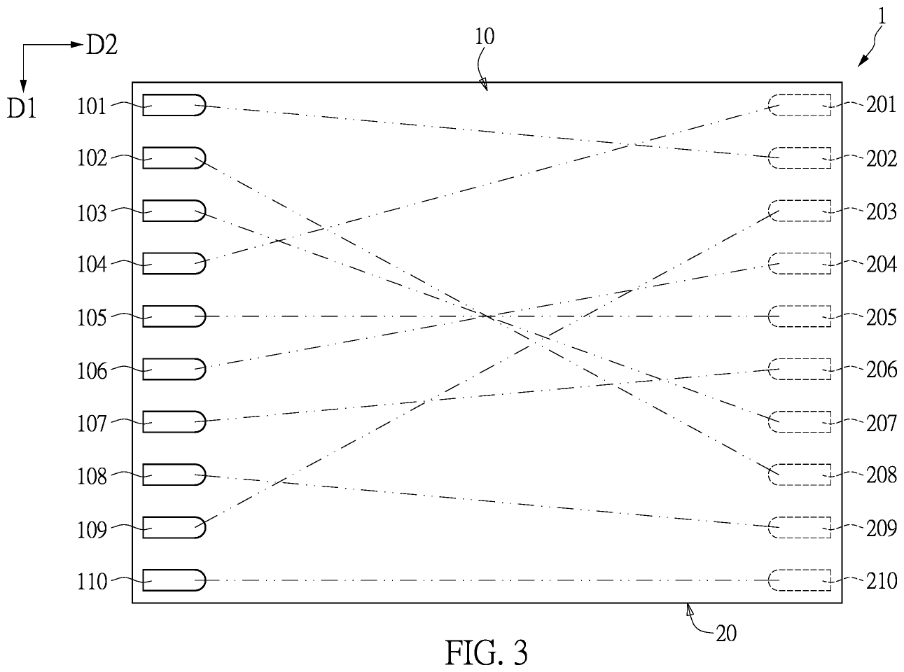

Further, referring to FIG. 3 together, FIG. 3 is a schematic diagram of a connection relationship between first contacts 101 to 110 and second contacts 201 to 210 in FIG. 2. As shown in FIG. 3, in this embodiment, at least according to the number of first contacts 101 to 110, it can be known that a total of 10 traces are predetermined to be laid out on the circuit board 1. In addition, in this embodiment, it can be assumed that the first contact 101 is electrically connected to the second contact 202 through a trace 301, and the first contact 102 is electrically connected to the second contact 208 through a trace 302, and so on. Corresponding connection relationships that the first contacts 101 to 110 and the second contacts 201 to 210 are connected through the traces 301 to 310 are summarized below in Table 1. From this, it can be seen that the traces 301 to 310 may be connected to the non-adjacent first contacts and second contacts.

TABLE 1

| First contact | Trace | Second contact |
|---|---|---|
| 101 | 301 | 202 |
| 102 | 302 | 208 |
| 103 | 303 | 207 |
| 104 | 304 | 201 |
| 105 | 305 | 205 |
| 106 | 306 | 204 |
| 107 | 307 | 206 |
| 108 | 308 | 209 |
| 109 | 309 | 203 |
| 110 | 310 | 210 |

It should be understood that a layout order of the traces 301 to 310 will be the key to the successful routing of the circuit board 1. In addition, in addition to meeting the above connection relationship in Table 1, the successful routing of the circuit board 1 also needs to meet the following conditions: the traces 301 to 310 cannot be interleaved before and after layer switching, and each trace can only be switched from the first trace layer 10 to the second trace layer 20 by using different via holes, that is, one via hole can only be used for assisting one trace in layer switching.

It should be noted that the so-called layer switching refers to a process of the trace crossing over from the first trace layer 10 to the second trace layer 20 through the corresponding via holes. The before layer switching refers to a process of traveling in the first trace layer 10 starting from the corresponding first contact and then reaching the corresponding via holes. The after layer switching refers to a process of passing through the corresponding via holes, then traveling in the second trace layer 20 and then reaching the corresponding second contact. However, a conventional routing method relies on the routing experience of a worker and the use of trial and error, without standardized flows or steps, thus wasting a large amount of time.

For the deficiencies of the prior art, embodiments of the present invention provide a routing method of FIG. 1, suitable for planning the traces 301 to 310 of the circuit board 1. The steps of the routing method can be performed by a plurality of modules of one or more electronic devices. These modules can be implemented by combining hardware with software and/or firmware, but the present invention does not limit the specific implementation of these modules. As shown in FIG. 1, in step S101, a plurality of virtual paths can be provided between the first contacts 101 to 110 and the second contacts 201 to 210 corresponding thereto in arrangement order through a setting module, and a plurality of virtual grid points can be provided on the virtual paths according to a number of the traces 301 to 310.

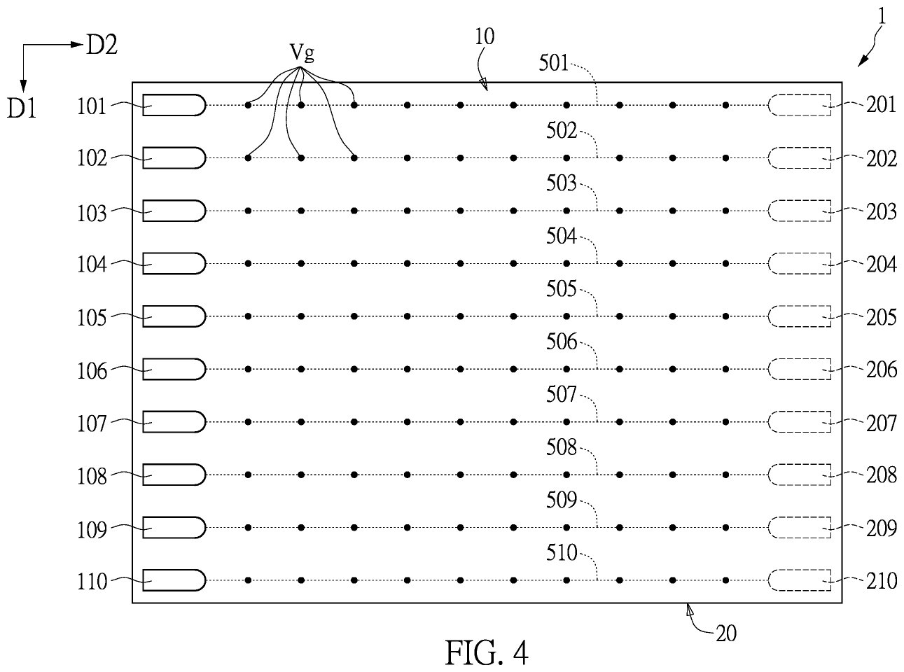

Specifically, referring to FIG. 4 together, FIG. 4 is a schematic diagram of a plurality of virtual paths and a plurality of virtual grid points according to an embodiment of the present invention. As shown in FIG. 4, the shortest connection path between a first contact and a second contact corresponding in arrangement order may be one of the virtual paths. Therefore, there may be a virtual path 501 between the first contact 101 and the second contact 201, and there may be a virtual path 502 between the first contact 102 and the second contact 202, and so on, there may be a virtual path 510 between the first contact 110 and the second contact 210. In addition, since the number of the traces 301 to 310 is 10, 10 virtual grid points Vg can be provided on each virtual path in this embodiment. In other words, a number of the virtual grid points Vg may be n*n, each of the virtual paths has n virtual grid points, and n is the number of the traces.

Then, in step S102, a plurality of first serial numbers of the first contacts 101 to 110 can be set according to the arrangement order of the first contacts 101 to 110 in the first direction D1 through a setting module, and a plurality of second serial numbers of the second contacts 201 to 210 can be set according to the arrangement order of the second contacts 201 to 210 in the first direction D1. In this embodiment, the first serial numbers of the first contacts 101 to 110 are equal to the second serial numbers of the second contacts of the second contacts 201 to 210 corresponding to the first contacts 101 to 110 in the arrangement order.

By way of examples, as shown in Table 2 below, according to the arrangement order of the first contacts 101 to 110 in the first direction D1, 1 can be added sequentially from 1 in this embodiment to set a plurality of first serial numbers of the first contacts 101 to 110. That is, the first serial number of the first contact 101 is set to 1, and the first serial number of the first contact 102 is set to 2, and so on, the first serial number of the first contact 110 is set to 10. In addition, according to the arrangement order of the second contacts 201 to 210 in the first direction D1, 1 can be added sequentially from 1 in this embodiment to set a plurality of second serial numbers of the second contacts 201 to 210. That is, the second serial number of the second contact 201 is set to 1, and the second serial number of the second contact 202 is set to 2, and so on, the second serial number of the second contact 210 is set to 10. In other words, the first serial numbers of the first contacts 101 to 110 and the second serial numbers of the second contacts 201 to 210 are set in the same way in this embodiment.

TABLE 2

| First | First | Second | Second |
|---|---|---|---|
| contact | serial number | contact | serial number |
| 101 | 1 | 201 | 1 |
| 102 | 2 | 202 | 2 |
| 103 | 3 | 203 | 3 |
| 104 | 4 | 204 | 4 |
| 105 | 5 | 205 | 5 |
| 106 | 6 | 206 | 6 |
| 107 | 7 | 207 | 7 |
| 108 | 8 | 208 | 8 |
| 109 | 9 | 209 | 9 |
| 110 | 10 | 210 | 10 |

Next, in step S103, multiple contact serial number differences between the second serial numbers of the second contacts 201 to 210 and the first serial numbers of the first contacts 101 to 110 can be calculated by a calculation module for the first contacts and the second contacts that are correspondingly connected to the plurality of traces. In step S104, the traces 301 to 310 can be divided into a first group, a second group and a third group according to the contact serial number differences by a classification and execution module. By way of examples, when the first serial numbers of the first contacts 101 to 110 and the second serial numbers of the second contacts 201 to 210 are set in increments in the first direction D1, it can be defined in this embodiment that the traces with the contact serial number differences being positive values are assigned to the first group, the traces with contact serial number differences being zero is assigned to the second group, and the traces with a contact serial number differences being a negative values are assigned to the third group.

Therefore, as shown in Table 3 below, the traces 301, 302, 303 and 308 can be divided into the first group, the traces 305 and 310 can be divided into the second group, and the traces 304, 306, 307 and 309 can be divided into the third group. In addition, the traces 301 to 310 will be laid out in order of the first group, the second group and the third group in this embodiment. In other words, in order of the first group, the second group and the third group, laying of the traces 301, 302, 303 and 308 will be prioritized in this embodiment until the traces 301, 302, 303 and 308 are all laid out. The traces 305 and 310 will then be laid out in this embodiment, and so on, and finally, the traces 304, 306, 307 and 309 are laid out.

TABLE 3

| First | | Second | Contact serial | |
|---|---|---|---|---|
| contact | Trace | contact | number difference | Group |
| 101 | 301 | 202 | 1 | First group |
| 102 | 302 | 208 | 6 | First group |
| 103 | 303 | 207 | 4 | First group |
| 104 | 304 | 201 | −3 | Third group |
| 105 | 305 | 205 | 0 | Second group |
| 106 | 306 | 204 | −2 | Third group |
| 107 | 307 | 206 | −1 | Third group |
| 108 | 308 | 209 | 1 | First group |
| 109 | 309 | 203 | −6 | Third group |
| 110 | 310 | 210 | 0 | Second group |

Finally, in step S105, a plurality of via holes 401 to 410 are provided on the virtual grid points according to the number of the traces 301 to 310. It should be noted that although providing the via hole of each trace on the virtual grid point closest to the first contact connected to the trace can greatly save space for the first trace layer 10 and the second trace layer 20, in order to meet the condition that these traces cannot be interleaved before and after layer switching, in the first group and the second group, the via hole of each trace is located on the virtual path corresponding to the first contact connected to the trace, and in the third group, the via hole of each trace is located on the virtual path corresponding to the second contact connected to the trace, so that the traces 301 to 310 cross over from the first trace layer 10 to the second trace layer 20 through the via holes 401 to 410 to connect the second contacts 201 to 210.

Specifically, the routing method of this embodiment of the present invention may further include: arranging the traces (i.e., the traces 301, 302, 303 and 308) of the first group in descending order of the second serial numbers of the second contacts connected to the traces of the first group. In other words, since the second contacts 202, 208, 207 and 209 connected to the traces 301, 302, 303 and 308 have the second serial numbers of 2, 8, 7 and 9, respectively, in descending order of the second serial numbers, the traces of the first group can also be laid out in laying order of the traces 308, 302, 303 and 301. In this embodiment, the next trace must be laid out after one of the traces 308, 302, 303 and 301 is laid out.

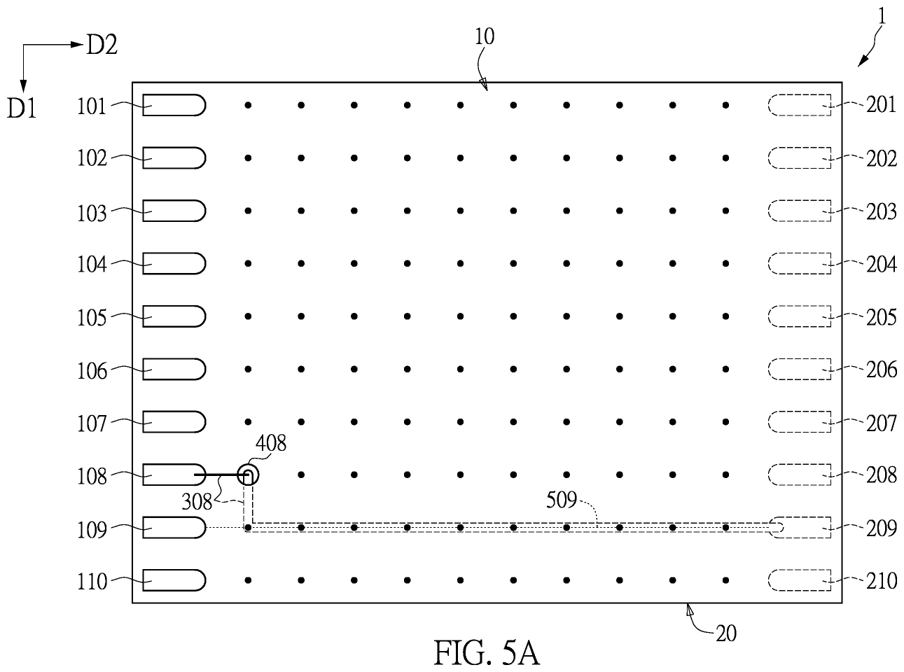

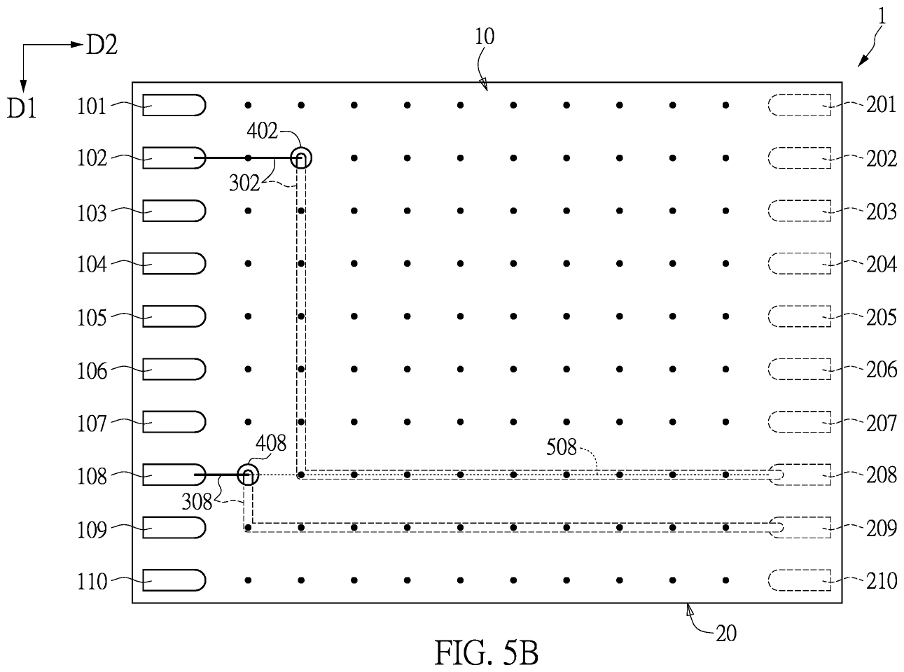

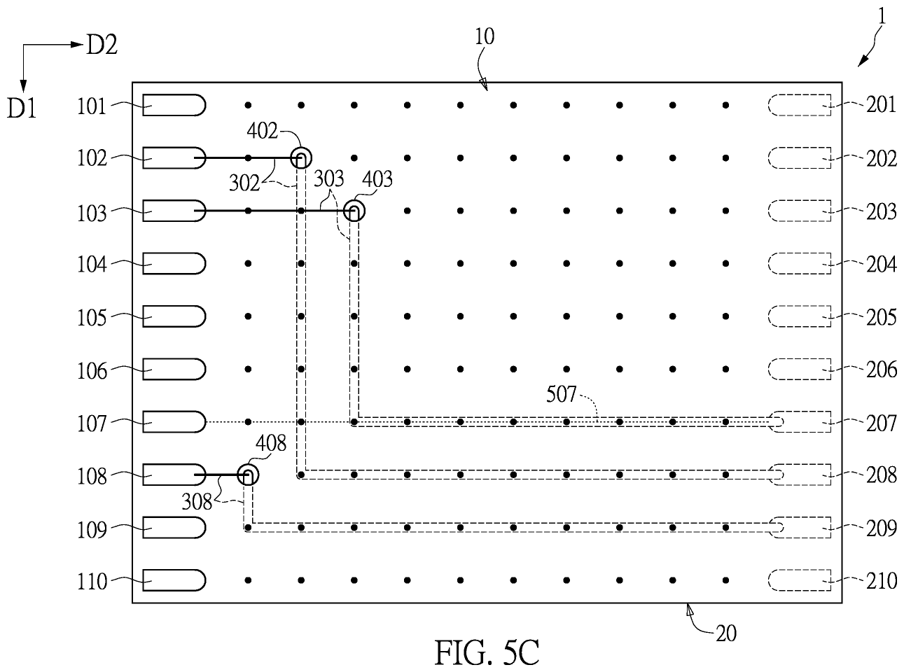

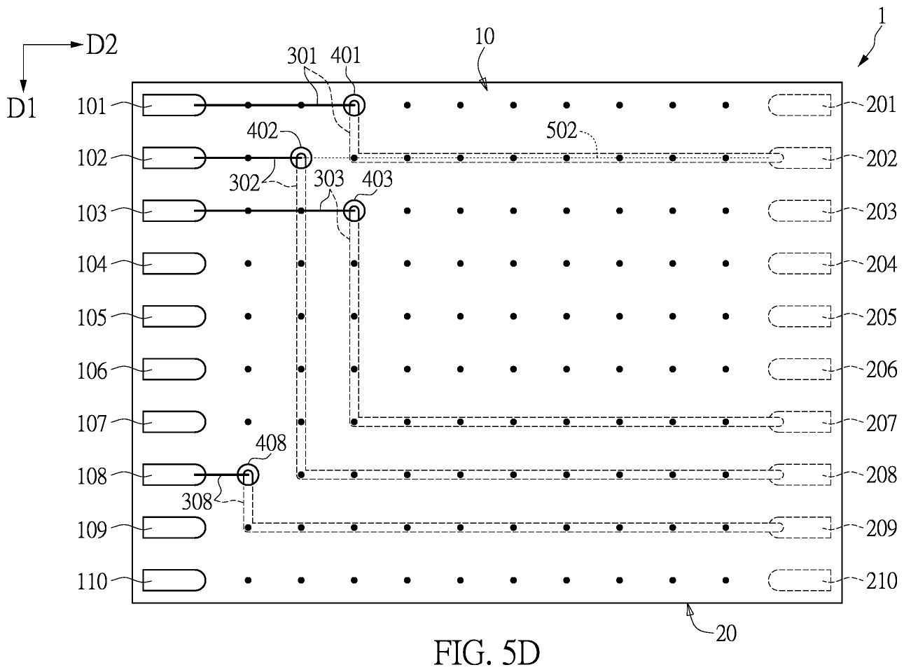

Referring to FIGS. 5A to 5D together, FIGS. 5A to 5D are schematic diagrams of laying traces of a first group according to an embodiment of the present invention. As shown in FIGS. 5A to 5D, the traces of the first group are laid out in the first trace layer 10 in a second direction D2 perpendicular to the first direction D1. That is, in this embodiment, it is not allowed that each trace of the first group has a turn on the first trace layer 10, and after each trace of the first group passes through the corresponding via hole from the first trace layer 10 to the second trace layer 20, each trace of the first group is laid out along the first direction D1 until reaching the virtual path corresponding to the second contact connected to the trace, and then is laid out in the second direction D2 to connect the second contacts.

For example, after passing through the corresponding via hole 408 from the first trace layer 10 to the second trace layer 20, the trace 308 is laid out in the first direction D1 until reaching the virtual path 509 corresponding to the second contact 209 connected to the trace 308, and then is laid out in the second direction D2 so as to connect the second contact 209, and so on, after passing through the corresponding via hole 401 from the first trace layer 10 to the second trace layer 20, the trace 301 is laid out in the first direction D1 until reaching the virtual path 502 corresponding to the second contact 202 connected to the trace 301, and then is laid out in the second direction D2 so as to connect the second contact 202. In other words, in this embodiment, each trace of the first group will include one turn in the second trace layer 20 to greatly save space for the first trace layer 10 and the second trace layer 20. Furthermore, if the above limit of the number of turns is exceeded, it cannot ensure that each trace of the first group is routed in the most streamlined and efficient manner in the second trace layer 20.

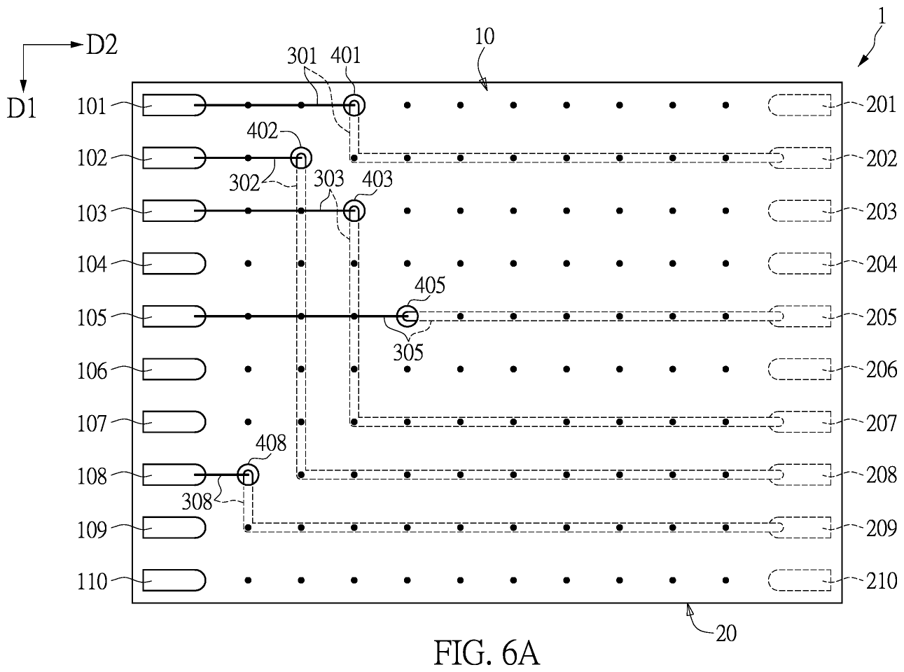

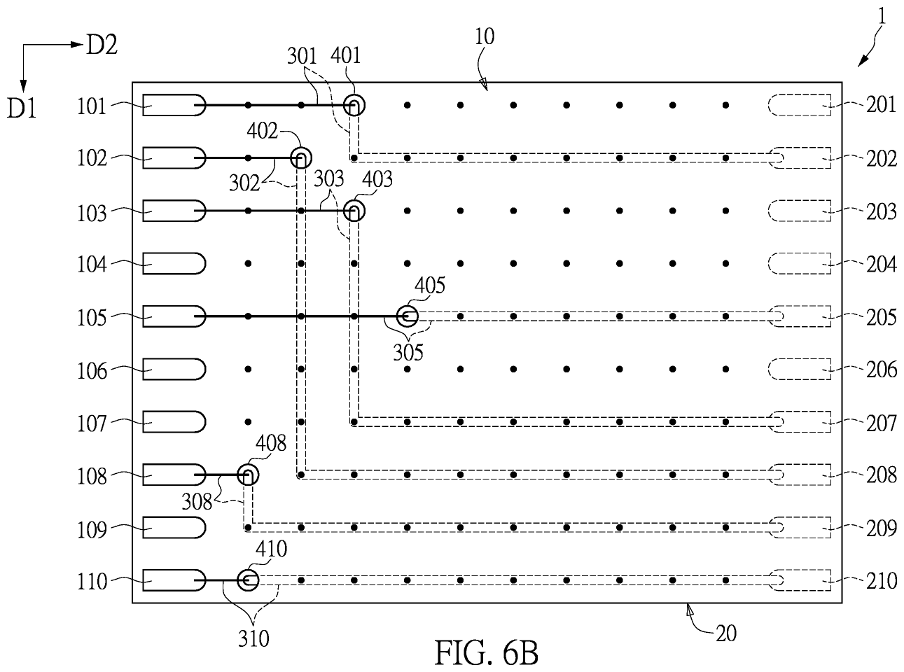

In another aspect, the routing method of this embodiment of the present invention may further include: the traces (i.e., traces 305 and 310) of the second group are laid out in ascending order of the second serial numbers of the second contacts connected to the traces of the second group. In other words, since the second contacts 205 and 210 connected to the traces 305 and 310 have the second serial numbers of 5 and 10, respectively, in ascending order of the second serial numbers, the traces of the second group can also be laid out in laying order of the traces 305 and 310. Referring to FIGS. 6A to 6B together, FIGS. 6A to 6B are schematic diagrams of laying traces of a second group according to an embodiment of the present invention. As shown in FIGS. 6A to 6B, the traces of the second group are laid out in the first trace layer 10 and the second trace layer 20 in the second direction D2.

For example, after passing through the corresponding via hole 405 from the first trace layer 10 to the second trace layer 20, the trace 305 only needs to be laid out in the second direction D2 so as to connect the second contact 205, and after passing through the corresponding via hole 410 from the first trace layer 10 to the second trace layer 20, the trace 310 only needs to be laid out in the second direction D2 so as to connect the second contact 210. In other words, in this embodiment, it is not allowed that each trace of the second group has a turn in the first trace layer 10 and the second trace layer 20. Similarly, if the above limit of the number of turns is exceeded, it cannot ensure that each trace of the second group is routed in the most streamlined and efficient manner in the first trace layer 10 and the second trace layer 20.

Finally, the routing method of this embodiment of the present invention may further include: the traces (i.e., traces 304, 306, 307 and 309) of the third group are laid out in ascending order of the first serial numbers of the first contacts connected to the traces of the third group. In other words, since the first contacts 104, 106, 107 and 109 connected to the traces 304, 306, 307 and 309 have the first serial numbers of 4, 6, 7 and 9, respectively, in ascending order of the first serial numbers, the traces of the third group can also be laid out in laying order of the traces 304, 306, 307 and 309. In this embodiment, the next trace must be laid out after one of the traces 304, 306, 307 and 309 is laid out.

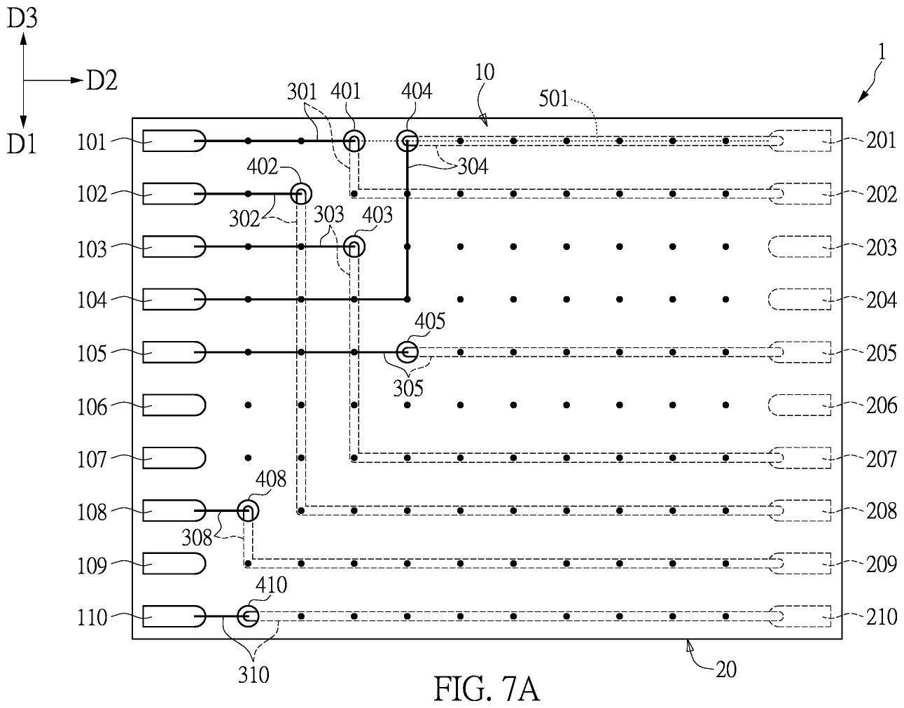

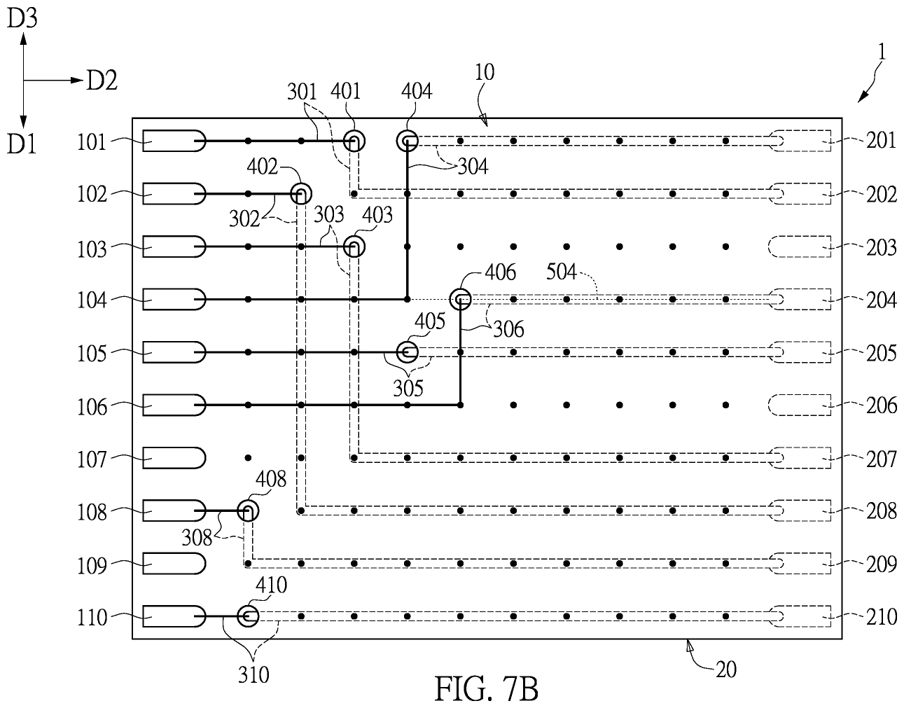

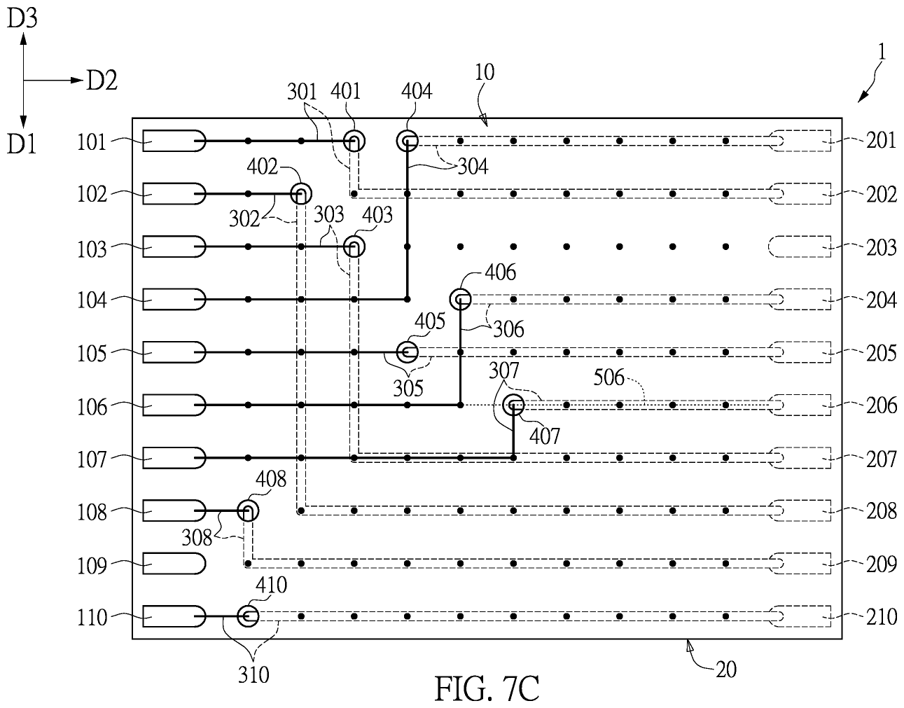

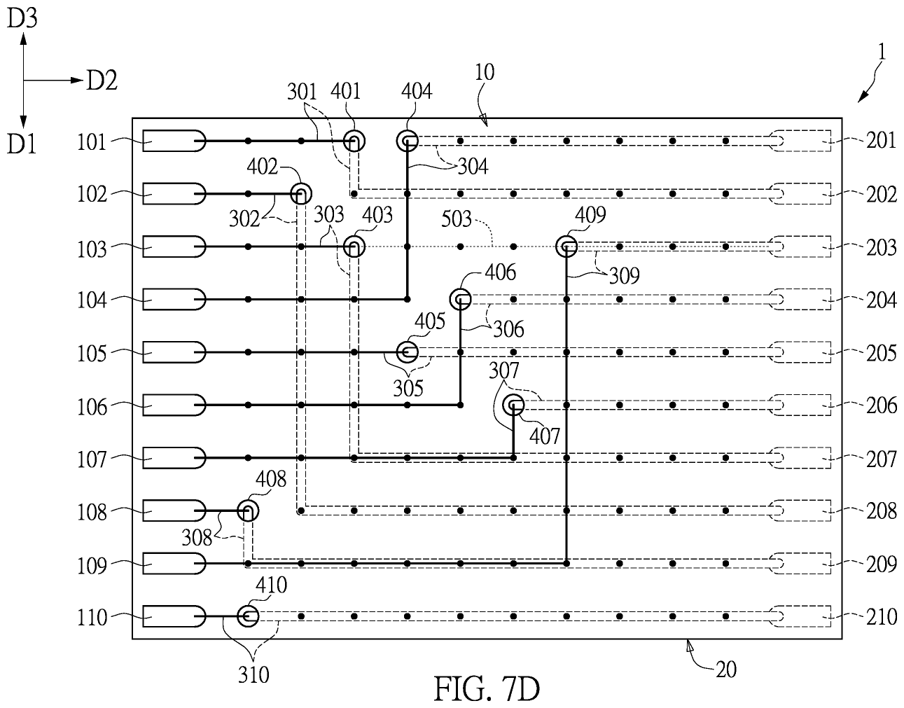

Referring to FIGS. 7A to 7D together, FIGS. 7A to 7D are schematic diagrams of laying traces of a third group according to an embodiment of the present invention. As shown in FIGS. 7A to 7D, each trace of the third group is laid out in the first trace layer 10 in the second direction D2, then is laid out in a third direction D3 opposite to the first direction D1 until reaching the virtual path corresponding to the second contact connected to the trace, and then passes through the via hole to the second trace layer 20. In addition, each trace of the third group is laid out in the second direction D2 after passing through the corresponding via hole from the first trace layer 10 to the second trace layer 20.

For example, the trace 304 is laid out in the first trace layer 10 in the second direction D2, then is laid out in the third direction D3 opposite to the first direction D1 until reaching the virtual path 501 corresponding to the second contact 201 connected to the trace 304, and then passes through the corresponding via hole 404 to the second trace layer 20. Next, the trace 304 is laid out in the second direction D2 so as to connect the second contact 201 after passing through the corresponding via hole 404 from the first trace layer 10 to the second trace layer 20. Similarly, the trace 309 is first laid out in the first trace layer 10 in the second direction D2, and then is laid out in the third direction D3 opposite to the first direction D1 until reaching the virtual path 503 corresponding to the second contact 203 connected to the trace 309, and then passes through the corresponding via hole 409 to the second trace layer 20. Next, the trace 309 is laid out in the second direction D2 so as to connect the second contact 203 after passing through the corresponding via hole 409 from the first trace layer 10 to the second trace layer 20. In other words, in this embodiment, different from each trace of the first group, each trace of the third group will include one turn in the first trace layer 10 to greatly save space for the first trace layer 10 and the second trace layer 20.

It should be noted that in other embodiments, the first serial number and the second serial number can be set by employing a decreasing way, and a grouping way also needs to be modified accordingly. Specifically, traces with a contact serial number difference of a negative value will be assigned to the first group instead, and traces with a contact serial number difference of a positive value will be assigned to the third group instead. Correspondingly, the traces of the first group will be laid out also in ascending order of the corresponding second serial numbers instead, and the traces of the third group will be laid out also in descending order of the corresponding first serial numbers instead. Since the relevant details have been described above, which will not be repeated here.

In summary, according to the routing method provided by the present invention, by the technical means of “providing the plurality of virtual paths between the first contacts of the first trace layer and the second contacts of the second trace layer, and providing the plurality of virtual grid points on the virtual paths according to the number of the traces”, “setting the plurality of first serial numbers of the first contacts and the plurality of second serial numbers of the second contacts in the same way”; “calculating the contact serial number difference”, “dividing the traces into the first group, the second group and the third group according to the contact serial number differences”, and “providing the plurality of via holes on the virtual grid points according to the number of the traces, wherein in the first group and the second group, the via hole of each trace is located on the virtual path corresponding to the first contact connected to the trace, and in the third group, the via hole of each trace is located on the virtual path corresponding to the second contact connected to the trace”, the traces cross over from the first trace layer to the second trace layer through the via holes so as to connect the second contacts. Therefore, one of the beneficial effects of the present invention is to propose standardized and clear flow steps so as to reduce reliance on the routing experience of a worker, thus avoiding wasting of a large amount of time.

The content provided above is only a preferred feasible embodiment of the present invention, and does not therefore limit the scope of the patent application of the present invention. Therefore, any equivalent technical changes made using the description and schematic content of the present invention are included in the scope of the patent application of the present invention.

What is claimed is:

1. A routing method for a circuit board, suitable for planning a plurality of traces of the circuit board, the circuit board comprising a plurality of first contacts provided on a first trace layer, and a plurality of second contacts provided on a second trace layer, the first contacts being arranged in a first direction, the second contacts being arranged in the first direction corresponding to the first contacts, and the first contacts being connected to the second contacts respectively by the traces, the routing method comprising:
providing a plurality of virtual paths between the first contacts and the second contacts corresponding thereto in arrangement order, and providing a plurality of virtual grid points on the virtual paths according to a number of the traces;
setting a plurality of first serial numbers of the first contacts according to the arrangement order of the first contacts in the first direction, and setting a plurality of second serial numbers of the second contacts according to the arrangement order of the second contacts in the first direction;
for the first contacts and the second contacts correspondingly connected to the plurality of traces, calculating multiple contact serial number differences between the plurality of second serial numbers of the second contacts and the plurality of first serial numbers of the first contacts;
dividing the traces into a first group, a second group and a third group according to the contact serial number differences; and
providing a plurality of via holes on the virtual grid points according to the number of the traces, wherein in the first group and the second group, the via hole of each trace is located on the virtual path corresponding to the first contact connected to the trace, and in the third group, the via hole of each trace is located on the virtual path corresponding to the second contact connected to the trace, so that the traces cross over from the first trace layer to the second trace layer through the via holes to connect the second contacts.

2. The routing method according to claim 1, wherein the first serial numbers of the first contacts are equal to the second serial numbers of the second contacts of the second contacts corresponding to the first contacts in the arrangement order.

3. The routing method according to claim 2, wherein when the first serial numbers and the second serial numbers are set in increments in the first direction, the traces with the contact serial number differences being positive values are assigned to the first group, the traces with the contact serial number differences being zero are assigned to the second group, and the traces with the contact serial number differences being negative values are assigned to the third group.

4. The routing method according to claim 3, further comprising: laying the traces of the first group in descending order of the second serial numbers of the second contacts connected to the traces of the first group.

5. The routing method according to claim 4, further comprising: laying the traces of the third group in ascending order of the first serial numbers of the first contacts connected to the traces of the third group.

6. The routing method according to claim 1, wherein a number of the virtual grid points is n*n, each of the virtual paths has n virtual grid points, and n is the number of the traces.

7. The routing method according to claim 1, wherein the traces of the first group are laid out in the first trace layer in a second direction perpendicular to the first direction, and after each trace of the first group passes through the corresponding via hole from the first trace layer to the second trace layer, each trace of the first group is laid out in the first direction until reaching the virtual path corresponding to the second contact connected to the trace, and then is laid out in the second direction to connect the second contacts.

8. The routing method according to claim 7, wherein the traces of the second group are laid out in the first trace layer and the second trace layer in the second direction.

9. The routing method according to claim 7, wherein each trace of the third group is laid out in the first trace layer in the second direction, then is laid out in a third direction opposite to the first direction until reaching the virtual path corresponding to the second contact connected to the trace, and then passes through the via hole to the second trace layer.

10. The routing method according to claim 9, wherein each trace of the third group is laid out in the second direction after passing through the corresponding via hole from the first trace layer to the second trace layer.

11. The routing method according to claim 1, wherein each of the traces of one of the first group and the third group comprises one turn in the second trace layer, and each of the traces of the other of the first group and the third group comprises one turn in the first trace layer.
